(19) United States
(12) Patent Application Publication
(10) Pub. No.: US 2010/0300232 A1
(43) Pub. Date: Dec. 2, 2010

(54) SHIFT ACTUATOR FOR MOTOR-BIKES

(75) Inventors: Mauro ZANELLA, Friedrichshafen (DE); Michael PANTKE, Friedrichshafen (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/779,081

(22) Filed: May 13, 2010

(30) Foreign Application Priority Data
May 28, 2009 (DE) 10 2009 026 543.0

(51) Int. Cl. F16H 61/32; F16H 59/04

(52) U.S. Cl. 74/473.12; 74/473.1; 74/473.18; 74/473.3

(57) ABSTRACT

An automated motorcycle transmission comprises a shift actuator (1) for engaging the gears of the transmission. The shift actuator (1) is a three-position actuator with self-maintaining end position stability which has first and second stable end positions and a stable central position. The shift actuator (1), when in the first end position, corresponds to a first gear of the transmission, the shift actuator (1), when in the second end position, corresponds to other gears of the transmission, and the shift actuator (1), when in the central position, corresponds to a neutral position of the transmission.

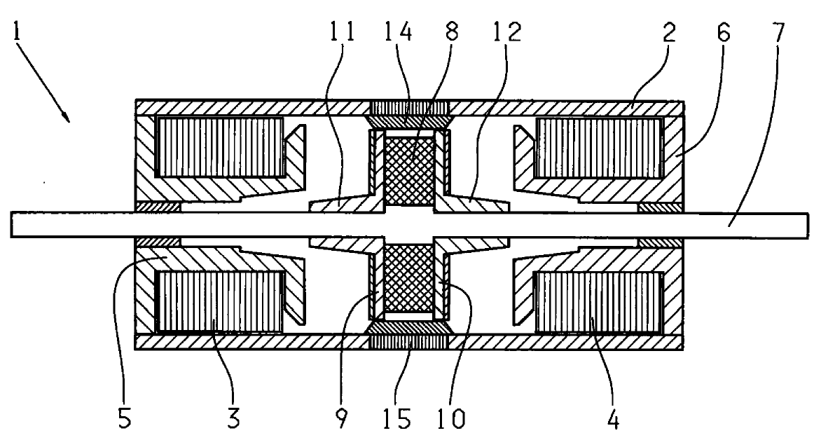

This application claims priority from German patent application serial no. 10 2009 026 543.0 filed May 28, 2009.

### FIELD OF THE INVENTION

The present invention relates to an automated transmission for motorcycles.

### BACKGROUND OF THE INVENTION

Motorcycles have a transmission which serves to pass on the movement of a crankshaft of the engine to the rear wheel. Motorcycle transmissions are shifted in a different manner from passenger car transmissions, since to engage the gears a foot-operated shift lever is provided, such that the first gear is as a rule engaged by pressing down from above and the other gears are shifted by pulling the shift lever upward in steps, with the shift lever springing back to its central position after every shift process; the idling or neutral position is usually located between the first and second gears.

Furthermore, for gear engagement as a rule the clutch is pulled by hand, but a shift can also be carried out without using the clutch. To do this the foot-operated shift lever is pushed upward while accelerating and held up, so that the next gear is engaged directly when the rider releases the accelerator. Since motorcycle transmissions are not synchronized, they cannot be damaged by such a procedure; in addition, neither does any greater wear take place.

From the prior art automated change-speed transmissions for passenger cars are known; however, automated motorcycle transmissions are not common.

From EP 1 936 224 A2 a motorcycle transmission is known, which comprises a clutch that is actuated in the disengaging and engaging directions by an actuator when the rider actuates a clutch lever.

Furthermore, from U.S. Pat. No. 6,070,485 A a device for shifting a transmission with a H-shift layout is known, in which an actuator comprising an electromagnet is used. This device can also be used with a motorcycle transmission.

From US 2006/0270520 A1 a device for shifting the gears of an automatic transmission is known, which also comprises at least one solenoid shift actuator.

Furthermore, from the not yet published document DE 10 2008 000 534 by the present applicant, whose entire content should be regarded as an object of this description, an electromagnetic control device is known which comprises a control element that can move longitudinally and can be retained in three stable positions, and two coils by which the control element can be switched to a first or to a second stable position, which constitute its end positions. In this known control device the control element comprises a control rod with a permanent magnet attached on it, and can be retained magnetically in the third stable position by the permanent magnet.

### SUMMARY OF THE INVENTION

The purpose of the present invention is to describe a motorcycle transmission in which the foot-operated shift lever is omitted and gears are engaged in an at least partially automated manner without needing to modify the basic transmission.

Accordingly a motorcycle transmission is proposed, which comprises a shift actuator for engaging the gears of the transmission, the shift actuator being a three-position actuator with self-maintaining end positions, therefore having two stable end positions and a stable central position.

According to a particularly advantageous embodiment of the invention, as the shift actuator an electromagnetic control device according to DE 10 2008 000 534 by the present applicant is used, which comprises a control element that can move longitudinally and can be retained in three stable positions, and two coils by which the control element can be switched to a first or to a second stable position, which constitute its end positions, the control element comprising a control rod with a permanent magnet attached on it, and being able to be retained magnetically in the third stable position by the permanent magnet.

According to the invention, one end position of the shift actuator corresponds to the first gear of the transmission, the third or middle (central) stable position corresponds to the neutral position of the transmission, and the second end position corresponds to the other gears of the transmission.

According to the invention, the clutch can be designed to be actuated manually or automatically.

Thanks to the concept according to the invention at least partially automated gearshifts can be carried out in motorcycles, scooters or four wheelers by simple and inexpensive means, without modifying the basic transmission.

### BRIEF DESCRIPTION OF THE DRAWING

Below, an example of the invention is explained in more detail with reference to the attached FIGURE, which shows a cross sectional view of a shift actuator used in accordance with the invention.

### DETAILED DESCRIPTION OF THE PREFERRED EMBODIMENTS

The attached FIGURE shows a shift actuator 1 according to DE 10 2008 000 534 by the present applicant. It comprises a cylindrical magnetic pole tube 2 at the end of which respective coils 3, 4, each with a respective yoke 5, 6, are arranged, the coils being connected to a current supply (not shown) so that they can be energized with current flowing in opposite directions in order to produce opposite polarities.

In addition a control or armature rod 7 arranged coaxially with the pole tube 2 is provided, which is fitted to slide in the two yokes 5, 6 and can move longitudinally. As can be seen in the FIGURE, approximately at the middle of the control rod 7 as viewed axially there is arranged a disk-shaped permanent magnet 8 which is fixed to the control rod 7, and at the end faces of the permanent magnet 8 flux-guide plates 9, 10 are arranged in order to strengthen the flux of the permanent magnet, with anti-adhesion disks or a coating that prevents sticking to the yokes 5, 6 arranged on the outside of the flux-guide plates 9, 10.

Furthermore, in each case on the end faces of the permanent magnet 8 and on the armature rod 7 conically shaped plunger armatures 11, 12 are arranged and attached, so that the control rod 7 and the permanent magnet 8, in combination with the flux-guide plates 9, 10, the anti-adhesion disks and the plunger armatures 11, 12, form the control element of the actuator 1.

As can be seen from the attached FIGURE, coaxially with the permanent magnet 8 and inside the pole tube 2 is arranged an annular holding pole 14 made from a magnetic material, which encloses the circumference of the permanent magnet 8, the inside diameter of the holding pole being smaller that that of the pole tube 2 so that the holding pole 14 forms a radial constriction of the pole tube 2. By virtue of the flux-guide plates 9, 10 together with the holding pole 14, the permanent magnet 8 forms a magnetic detent, i.e. the permanent magnet 8 and with it the control rod 7 are held in the position illustrated in the FIGURE by the magnetic force of the permanent magnet 8.

The permanent magnet 8 is such that its polarity is directed along the armature rod 7, and radially outside the holding pole 14 there is arranged a central coil 15 whose function, when energized, is to produce a magnetic field which compensates the magnetic field of the permanent magnet 8. This enables the control element of the actuator to move away more easily and quickly to one or the other of its end positions and thus improves the dynamic response of the shift actuator 1. The permanent magnet 8 or control element of the actuator is moved away from its central position by energizing one or both of the coils 3, 4 so that either a force of attraction, or a force of attraction from one coil and a force of repulsion from the other coil act(s) upon the permanent magnet 8. In the central position neither of the two coils 3, 4 is energized.

When the permanent magnet 8 impacts against the yoke 5 or 6, the respective plunger armature 11 or 12 moves into a corresponding, also conically shaped opening of the yoke 5 or 6, the result of this being that the magnetic attraction or repulsion force increases; by virtue of the anti-adhesion disks, permanent sticking of the permanent magnet 8 in one of the two end positions it effectively prevented.

The actuator 1 has three stable positions, namely two end positions and a central position, and is therefore tri-stable. In the two end positions the permanent magnet 8 holds the control element magnetically fast onto the yoke 5 or 6 and thereby establishes two stable end positions in which the coils 3 and 4 are no longer energized.

One such end position of the shift actuator corresponds to the first gear of the transmission, the other end position to the other gears of the transmission, and the central position to the neutral position of the transmission.

According to the invention, the foot-operated shift lever known from the prior art is omitted and is preferably replaced by the actuator described here. For example, the actuator can be operated by at least one knob or by switch-levers appropriately arranged on the handle bar.

### INDEXES

1 Shift actuator
2 Pole tube
3 Coil
4 Coil
5 Yoke
6 Yoke
7 Control rod
8 Permanent magnet
9 Flux-guide plate
10 Flux-guide plate
11 Plunger armature
12 Plunger armature
13 Holding pole
14 Central coil

1-5. (canceled)

6. An automated motorcycle transmission comprising:
an actuator (1) for engaging gears of the transmission,
the actuator (1) being a three-position actuator having three stable positions with self-maintaining end position retention, and
the three stable positions of the actuator being first stable end position, a second stable end position and a stable central position.

7. The automated motorcycle transmission according to claim 6, wherein the first stable end position of the shift actuator (1) corresponds to a first gear of the transmission, the second stable end position corresponds to other gears of the transmission, and the stable central position corresponds to a neutral position of the transmission.

8. The automated motorcycle transmission according to claim 6, wherein the shift actuator (1) is an electromagnetic control device which comprises a control element that is longitudinally movable and is retainable in each of the three stable positions, and first and second coils by which the control element is switched to one of the first stable end position and the second stable end position, each constituting an end position of the control element, and the control element comprises a control rod with a permanent magnet fixed thereto such that the control element is magnetically retainable in the stable central position by the permanent magnet.

9. The automated motorcycle transmission according to claim 6, wherein the clutch of the transmission is actuated one of manually and automatically.

10. The automated motorcycle transmission according to claim 6, wherein the shift actuator (1) is operable by at least one of a knob and switch-lever arranged on a handle bar.

11. An actuator (1) of an automated motorcycle transmission for engaging gears of the transmission, the actuator comprising:
a cylindrical pole tube (2) and first and second coils (3, 4),
the first coil (3) is retained within the pole tube (2) at a first end thereof by a yoke (5) and the second coil (4) being retained within the pole tube (2) at a second end thereof by another yoke (6),
a disk shaped permanent magnet (8) being fixed to a control rod (7) extending coaxially with and within the pole tube (2), the control rod (7) being axially slidable such that the permanent magnet (8) slides between a first end position, adjacent the first coil (3), a second end position, adjacent the second coil (4) and a central position, located centrally between the first and the second end positions,
the shift actuator (1) is operated by energization of at least one of the first coli (3) and the second coil (4) such that the shift actuator (1), when in the first end position, corresponds to a first gear of the transmission, the shift actuator (1), when in the second end position, corresponds to other gears of the transmission, and the shift actuator (1), in the central position, corresponds to a neutral position of the transmission.
